(19) United States
(12) Patent Application Publication
(10) Pub. No.: US 2017/0307258 A1
(43) Pub. Date: Oct. 26, 2017

(54) SINGLE AXIS ROTATION SYSTEM FOR USE WITH A SOLAR DEVICE

(71) Applicants: Glenn Jakins, Provo, UT (US); Jack E. Cluff, St. George, UT (US)

(72) Inventors: Glenn Jakins, Provo, UT (US); Jack E. Cluff, St. George, UT (US)

(21) Appl. No.: 15/136,946

(22) Filed: Apr. 24, 2016

(51) Int. Cl. F24J 2/38; F16H 19/00; F16H 19/06

(52) U.S. Cl. CPC F24J 2/38; F16H 19/06; F16H 19/005; F16H 2019/0686

(57) ABSTRACT

The present disclosure is drawn to single axis rotation systems for use with a solar device, as well as related methods and sun movement targeting devices. The single axis rotation system can include an actuator with a movable arm, a pulley system, and a rotatable shaft. The pulley system can include a base pulley, a collaborative pulley, and a compliant band about the base pulley and the collaborative pulley. The movable arm can be attached to the compliant band such that when the movable arm actuates, the compliant band causes the base pulley and the collaborative pulley to move. The rotatable shaft is attached to the base pulley and is configured to rotate when the base pulley rotates, as well as rotate a solar device along a single axis in an outward orientation with respect to the rotatable shaft.

### CROSS REFERENCE TO RELATED APPLICATIONS

Priority is claimed from U.S. Provisional Patent Application 62/152,530, filed 24 Apr. 2015, which is hereby incorporated by reference

### BACKGROUND

Most people utilize electrical devices that consume electrical energy on a daily basis. Electricity has become an integrated part of everyday life and is required to power modern day essentials and conveniences. In light of the high and ever increasing demands on electricity and decreasing energy reserves, alternative energy sources are in continual demand. One popular source of alternative energy is solar energy. Solar energy is an affordable renewable energy source that harnesses radiant light and heat from the sun. Solar energy can be converted into electricity by photovoltaics on a solar panel. However, the more efficient solar panels only harness around 30% of the energy available. Solar tracking devices when used in conjunction with a solar panel can increase annual output by about 30%. As a result, systems that increase the efficiency of solar technologies are in demand.

### SUMMARY

The present disclosure is drawn to a single axis rotation system for use with a solar device. In one embodiment, the single axis rotation system comprises an actuator, a pulley system, and a rotatable shaft. The actuator comprises a movable arm. The pulley system comprises a base pulley, a collaborative pulley, and compliant band about the base pulley and the collaborative pulley. The movable arm can be attached to the compliant band such that when the movable arm actuates, the compliant band causes the base pulley and typically the collaborative pulley to move. The rotatable shaft can extend through the base pulley and can be configured to rotate when the base pulley rotates. The rotatable shaft can be configured to be attached to a solardevice to rotate the solar device along a single axis in an outward orientation with respect to the rotatable shaft.

In another embodiment, a single axis rotation system for use with a solar device is presented having an actuator, a pulley system, a rotatable shaft, and a sun following sensor. The actuator comprises a movable arm and body with a motor. The motor can be configured to extend and retract the movable arm from the body. The pulley system can comprise a base pulley, a collaborative pulley, and compliant band about the base pulley and the collaborative pulley. The movable arm of the actuator can be attached to the compliant band such that when the movable arm actuates, the compliant band causes at least the base pulley to move. The rotatable shaft extends through the base pulley. The rotatable shaft can be configured to rotate when the base pulley rotates. The rotatable shaft can further be configured to be attached to a solar device to rotate the solar device along a single axis in an outward orientation with respect to the rotatable shaft. The sun following sensor can be adapted to communicate with the actuator and direct the actuator to extend or retract, thereby causing the solar device, when installed, to follow the sun.

Also presented, are methods of tracking the sun for efficient use of a solar device. The method comprises affixing a solar device to a single axis rotatable support body with an operable face of the solar device positioned opposite the single axis rotatable body. The single axis rotatable body can be fixably coupled to a base pulley of a pulley system which can be rotated by a movable arm of an actuator attached to a compliant band wrapped around the base pulley.

When the base pulley rotates, it can cause rotation of the single axis rotatable body. The method further includes attaching a sun following sensor to the solar device in an orientation that can be functionally aligned with the face of the solar device and electrically coupling the sun following sensor to the actuator. The sun following sensor can also be configured to electrically communicate information regarding position of the sun to the actuator to direct the face of the solar device toward the sun along the single axis.

In another example, a sun movement targeting device for use with a single axis rotational solar device is disclosed. The sun movement targeting device can comprise an opaque surface with an optical opening to allow a spot of direct sunlight therethrough, an optical target, and a fastening portion. The optical target can be positioned at from 3 to 10 inches directly beneath the opaque surface, and have tracking axes included thereon. The fastening portion can be configured to attach the sun movement targeting device in an operational coplanar or parallel orientation with respect to a flat surface of a solar device.

There has thus been outlined, rather broadly, various features of the technology so that the detailed description thereof that follows may be better understood, and so that the present contribution to the art may be better appreciated. Other features of the present technology will become clearer from the following detailed description, taken with the accompanying drawings and claims, or may be learned by the practice of the technology.

### BRIEF DESCRIPTION OF DRAWINGS

Features and advantages of the technology will be apparent from the detailed description that follows, taken in conjunction with the accompanying drawings, together illustrate features of the technology. It is understood that these drawings merely depict exemplary embodiments and are not, therefore, to be considered limiting in scope. Furthermore, it will be readily appreciated that the components, as generally described and illustrated in the figures herein, could be arranged and designed in a wide variety of different configurations.

FIG. 1 schematically shows a perspective view of an actuator, pulley system, rotatable shaft, first support body, second support body, and engaging mechanism in accordance with examples of the present disclosure;

FIG. 2 depicts a close up perspective view of the solar device, pulley system, actuator, first support body, and guide in accordance with examples of the present disclosure;

FIG. 3A schematically depicts a lower plan view of the pulley system, rotatable shaft, guide, and first support body in accordance with examples of the present disclosure;

FIG. 3B schematically depicts a side view device shown in FIG. 3A in accordance with examples of the present disclosure;

FIG. 4 schematically depicts a perspective view of the exterior side or face of a solar panel connected to the single axis rotation system (not visible) and stand (portion visible) having the sun movement targeting device and a sun following sensor attached to the solar panel frame in accordance with examples of the present disclosure;

FIG. 5 schematically depicts a view of a stand with charge controller, battery support, and battery in accordance with examples of the present disclosure;

FIG. 6 depicts a rear view of a solar panel connected to the single axis rotation system, the stand, sun movement targeting device, and sun following sensor in accordance with examples of the present disclosure;

FIG. 7 depicts a close up perspective view of a sun following sensor removably coupled to a solar panel in accordance with examples of the present disclosure;

FIG. 8 schematically depicts the sun movement targeting device with an opaque surface, optical opening, and tracking axis in accordance with examples of the present disclosure; and

FIGS. 9A-9C schematically depict various solar devices that can be used in accordance with examples of the present disclosure.

These drawings are provided to illustrate various aspects of the technology and are not intended to be limiting in terms of dimensions, materials, configurations, arrangements, or proportions unless otherwise limited by the claims.

### DETAILED DESCRIPTION

Reference will now be made to exemplary embodiments and specific language will be used herein to describe the same. It will nevertheless be understood that no limitation of the scope of the present technology is thereby intended. Alterations and further modifications of the inventive features described herein, and additional applications of the principles of the technology as described herein, which would occur to one skilled in the relevant art and having possession of this disclosure, are to be considered within the scope of the technology. Further, before particular embodiments are disclosed and described, it is to be understood that this technology is not limited to the particular process and materials disclosed herein as such may vary to some degree. It is also to be understood that the terminology used herein is used for the purpose of describing particular embodiments only and is not intended to be limiting, as the scope of the present technology will be defined only by the appended claims and equivalents thereof.

It is noted that, as used in this specification and the appended claims, the singular forms “a,” “an,” and “the” include plural referents unless the context clearly dictates otherwise. Thus, for example, reference to “a engaging mechanism” includes one or more of such engaging mechanisms and reference to “a axis” includes reference to one or more of such axis.

As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

In this disclosure, “comprises,” “comprising,” “comprised,” “containing” and “having” and the like can have the meaning ascribed to them in U.S. Patent law and can mean “includes,” “including,” and the like, and are generally interpreted to be open ended terms. The term “consisting of” is a closed term, and includes only the methods, compositions, components, systems, steps, or the like specifically listed, and that which is in accordance with U.S. Patent law. “Consisting essentially of” or “consists essentially” or the like, when applied to devices, methods, compositions, components, structures, steps, or the like encompassed by the present disclosure, refer to elements like those disclosed herein, but which may contain additional structural groups, composition components, method steps, etc. Such additional devices, methods, compositions, components, structures, steps, or the like, etc., however, do not materially affect the basic and novel characteristic(s) of the devices, compositions, methods, etc., compared to those of the corresponding devices, compositions, methods, etc., disclosed herein. In further detail, “consisting essentially of” or “consists essentially” or the like, when applied to the methods, compositions, components, systems, steps, or the like encompassed by the present disclosure have the meaning ascribed in U.S. Patent law and is open-ended, allowing for the presence of more than that which is recited so long as basic or novel characteristics of that which is recited is not changed by the presence of more than that which is recited, but excludes prior art embodiments. In this specification when using an open ended term, like “comprising” or “including,” it is understood that direct support should be afforded also to “consisting essentially of” language as well as “consisting of” language as if stated explicitly and vice versa.

Dimensions, amounts, angles, distance, and other numerical data may be presented herein in a range format. It is to be understood that such range format is used merely for convenience and brevity and should be interpreted flexibly to include not only the numerical values explicitly recited as the limits of the range, but also to include all the individual numerical values or subranges encompassed within that range as if each numerical value and sub-range is explicitly recited. For example, from about 120° to about 180° should be interpreted to include not only the explicitly recited limits of about 120° and about 180°, but also to include individual angles such as 130°, 140°, 150°, 160°, and 170° and sub-ranges such as 130° to 150° and 160° to 180°, etc.

As used herein, “attachment side” refers to the side of the solar device to which the single axis rotation system is to be secured. As used herein “exterior side” or “face” refers to the side of a solar device or part thereof that faces outwardly towards the sun. For example, an exterior side of solar panel may be a side facing toward the sun when in use, while by comparison, an attachment side is a side of the solar panel facing away from the sun to which the single axis rotation system is coupled (usually to a supporting frame around the solar panel). The exterior side is the side of the component that faces outward or outmost and is exposed.

As used herein, “solar device” refers to an apparatus that collects, absorbs, reflects, and/or focuses sunlight. Non-limiting examples of solar devices include solar panels, solar dishes, solar reflectors, solar fluid heaters, solar hot water heaters, solar parabolic troughs, solar air heaters, solar cookers, solar absorbers, solar reflectors, lenses, mirrors, heliostats, linear Fresnel reflectors, etc.

As used herein, a plurality of items, structural elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims unless otherwise stated.

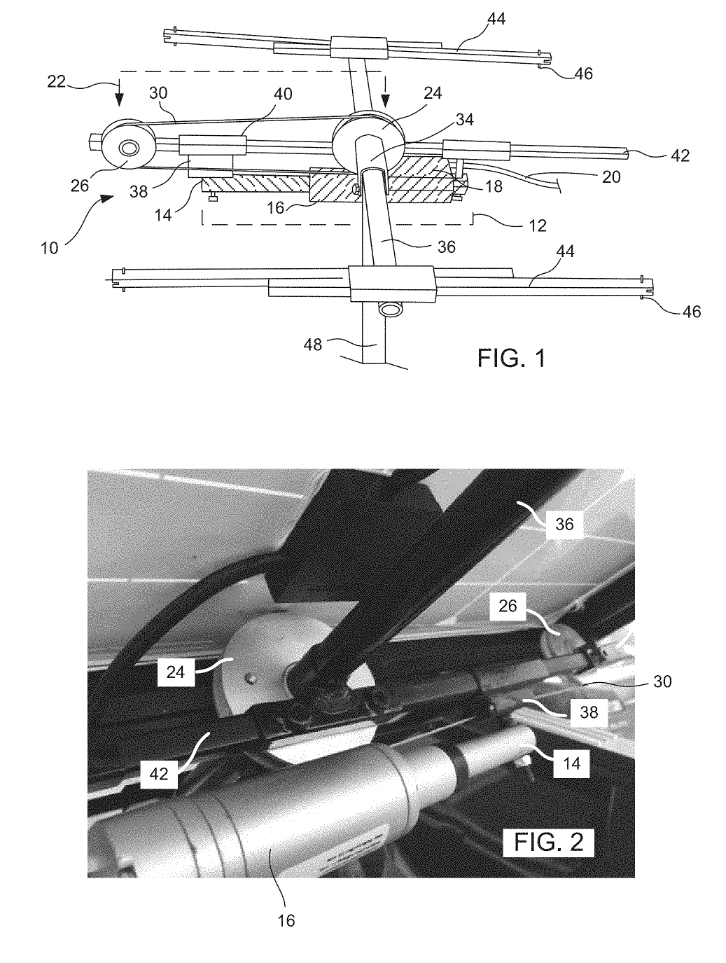

In accordance with this, a single axis rotation system for use with a solar device can include various components, such as some or all of the components shown by example in FIG. 1. Specifically, a single axis rotation system, as shown in FIG. 1, can include an actuator 12, a pulley system 22, and a rotatable shaft 36. The actuator can include a movable arm 14. The pulley system can be comprised of a base pulley 24, a collaborative pulley 26, and a compliant band 30. The compliant can be wrapped around the base pulley and the collaborative pulley. The movable arm of the actuator can be attached to the compliant band. This attachment configuration can allow the movable arm, when actuated, to move the compliant band and cause the base pulley and typically the collaborative pulley to move.

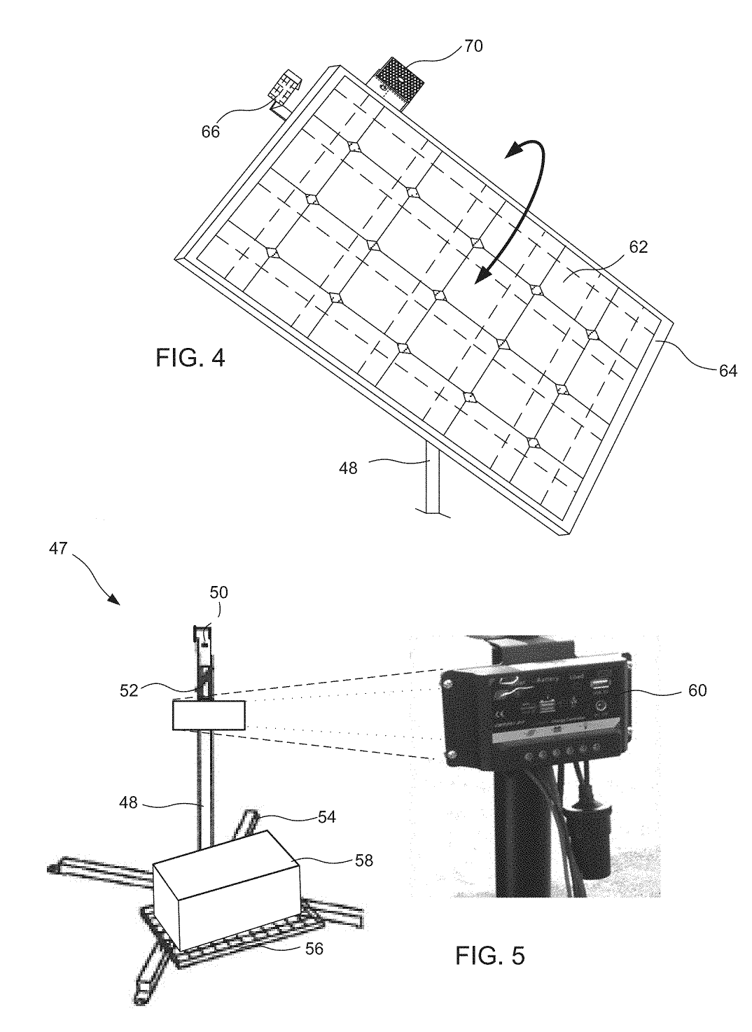

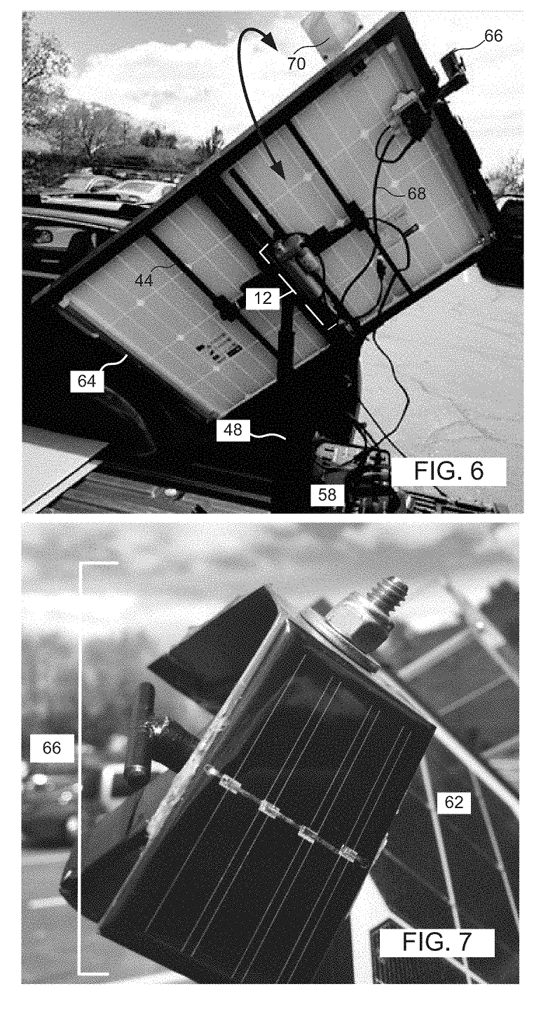

In one embodiment, the movement of the pulleys will be in a rotational direction. The rotatable shaft can extend through the base pulley and can be configured to rotate along with the base pulley, i.e. when the base pulley rotates. The rotatable shaft can further be configured to attach to a solar device (not shown, but shown as a solar panel in FIG. 4 and FIG. 6 and as other solar devices in FIGS. 9A-9C) to allow for rotation of the solar device along a single axis in an outward orientation with respect to the rotatable shaft.

In additional detail, the actuator 12 can provide the driving force for the single axis rotation system. (See FIG. 1 and FIG. 2). The actuator can be a pneumatic, electric, or mechanical. The actuator can be comprised of metals, plastic, ceramic materials, or combinations thereof. In some embodiments, the actuator 12 can be comprised of movable arm 14. In other embodiments, the actuator can further include a body 16 and a motor (shown at about 18, but inside a housing). When the actuator includes a motor, the motor can be configured to actuate the movable arm, thereby extending or retracting the movable arm in a linear direction into and out of (partially) the body.

In one embodiment, the movable arm can extend past the body of the actuator at from about 3 to 12 inches, e.g., about 3, about 4, about 5, about 6, about 7, about 8, about 9, about 10, about 11, or about 12, inches. The attachment of the movable arm to the pulley system can allow for relatively larger rotational movement with smaller movement of the movable arm. In one embodiment, the movable arm can be adapted to generate at least 120 degrees of motion for the solar device, when installed, by movement of no more than 10 inches. In another embodiment, the movable arm can be adapted to generate at least 150 degrees of motion for the solar device, when installed, by movement of no more than 6 inches. In yet another embodiment, the movable arm can be adapted to generate at least 180 degrees of motion for the solar device, when installed, by movement of no more than 12 inches.

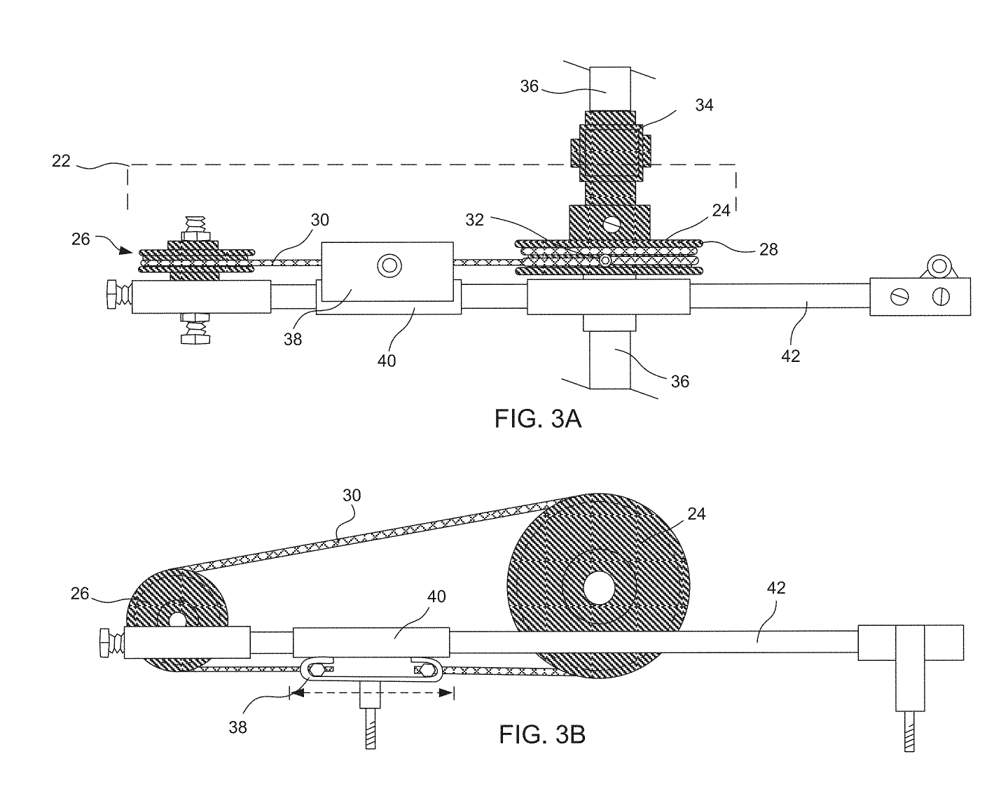

The pulley system 22 can be comprised of multiple pulleys. (see FIGS. 1, 3A, and 3B.) In one embodiment, the pulley system can be comprised of at least two pulleys. The two pulleys can be comprised of a base pulley 24 and a collaborative pulley 26. The pulley system can be a movable pulley system or a compound pulley system. When the pulley system is a compound pulley system, the base pulley can be the movable pulley in the system. The pulleys can be a sprocket pulley, a crown pulley, a drum pulley, a wing pulley, or a combination thereof. In one embodiment, the base pulley can include a sprocket pulley or a crown pulley. The rim 28 of the pulley can be flat, convex, or grooved. (see FIG. 3A.) In one embodiment, the base pulley is located at or near a central axis about the rotatable shaft and the collaborative pulley is distal to the central axis.

The pulley system 22, can further comprise a compliant band 30. (see FIGS. 1, 3A, and 3B.) The compliant band can be comprised of a rope, cable, cord, chain, or belt. In one embodiment, the compliant band can be affixed to the base pulley 24, such as by a set screw 32. (see FIG. 3A.) In one embodiment, the compliant band can be a rope that can be affixed to the base pulley by a set screw. In another embodiment, the compliant band can be a cable that can be affixed to the base pulley by a set screw. The compliant band can be wrapped around the base pulley multiple times. The exact wrapping will depend upon the circumference of the base pulley, the length of the compliant band, and the distance of movement of the movable arm. In one embodiment, the compliant band can be wrapped around the base pulley once. In a second embodiment, the compliant band can be wrapped around the base pulley at least twice. In yet another embodiment, the compliant band can be wrapped around the base pulley at least three times. In some embodiments, the compliant band can be a chain and the base pulley can be a sprocket pulley. In another embodiment, the compliant band can be a belt and the base pulley cab be a crowned pulley or a drum pulley.

As previously mentioned, and referring to FIGS. 1-3B, connecting the pulley system 22 to the moveable arm 14 can allow for a larger rotational movements with a smaller movable arm movement. In one embodiment, this connection occurs by a guide 38 that connects the movable arm to the compliant band 30. (see FIGS. 1 and 3B.) The attachment allows for the guide to actuate in a linear direction within the plane of the body of the actuator 16 (not shown in FIG. 3B). The attachment of the compliant band to the base pulley 24 can be configured to rotate the base pulley and/or the collaborative pulley 26. The guide can be further attached to a first support body 42. The attachment of the guide to the first support body can be by a slide bracket 40 that is guided along along the first support body in a linear direction parallel to the movement of the movable arm. At the same time, the body/motor is fixed to the first support body in this example.

The rotatable shaft 36 of the single axis rotation system can be any shape in cross-section (see FIGS. 1, 2, and 3A), but is typically a tube-like structure. In some embodiments, the rotatable shaft can be round in cross-section. In other embodiments, the rotatable shaft can be polygonal, e.g., square, pentagonal, hexagonal, octagonal, etc., in cross-section. The shaft can extend through the base pulley 24 at or near the center of the base pulley. The rotatable shaft can be connected to the base pulley in a manner that rotates the rotatable shaft when the base pulley is rotated. The rotatable shaft can be configured to be connected at each terminal end to a second support body 44.

The second support bodies 44 can include engaging mechanisms 46 for attaching the single axis rotation system 10 to a solar device 62. (see FIGS. 1, 4, and 6.) The engaging mechanism can be include any fastener used to secure the single axis rotation system to a solar device or solar device rim. In some embodiments, the engaging mechanism can include a fastener, screw, bolt, nut, pinchable retaining clips, or a screw clip.

In another embodiment, the single axis rotation system can be connected to the solar device at the solar device frame or rim 64. In one embodiment, the single axis rotation system can be connected to a solar panel at the solar panel frame. In one embodiment, the engaging mechanism is operable to releasably fasten the second support body to a solar device frame of the solar device.

The solar device can be an apparatus that collects, absorbs, or reflects sunlight. In one embodiment, a solar device can be selected from the group consisting of solar panels, solar dishes, solar reflectors, solar hot water heaters, solar parabolic troughs, solar air heaters, solar cookers, solar absorbers, solar reflectors, lenses, mirrors, heliostats, linear Fresnel reflectors, and the like. In one embodiment, the solar device can be solar panel, (see FIG. 4 and FIG. 6). In another embodiment, the solar device can be a solar dish 80. (see FIG. 9A.) In yet another embodiment, the solar device can be a lens 82. (see FIG. 9B.) In a further embodiment, the solar device can be a solar parabolic trough 84. (see FIG. 9C.) Other solar devices not shown can also be used, as previously listed, or which are known to have properties that would benefit from enhanced sun exposure.

When the single axis rotation system 10 is attached to a solar device 62, the system can further include a sun following sensor 66. (see FIG. 4 and FIG. 7). The sun following sensor can be removably attached to the solar device at the solar device frame 64 by an engaging mechanism. The engaging mechanism can be of the same type of fasteners previously discussed. The fastener can be configured to allow the sun following sensor to be adjustable. The sun following sensor can be adapted to communicate with the actuator 12. In one embodiment, the communication can be configured to occur via a direct cable connection between the actuator and the sun following sensor by a sun following sensor cable 68. In another embodiment, the communication can be configured to occur wirelessly based on radio signals. When the sun following sensor is adapted to communicate with the actuator, the sun following sensor can be configured to direct the actuator to extend or retract the movable arm 14, thereby causing the solar device, when installed, to follow the sun.

In another embodiment, when the single axis rotation system 10 is connected to a solar device, the system can further comprise a sun movement targeting device 70. (see FIGS. 4, 6, and 8.) In some embodiments, the sun movement targeting device can comprise a fastening portion 81 that allows the sun movement targeting device to detachably installed to the solar device frame 64. When attached, the sun movement targeting device, the sun movement targeting system can be functionally aligned with an exterior sun interfacing surface of the solar device. For example, if the solar devices is a flat solar panel, the sun movement targeting system can be installed in a coplanar or parallel position with respect to the flat surface of the solar panel to assist in determining a single axis that faces the sun over a period of time during daylight hours. In one embodiment, the period of time can be at least 2 hours. In another embodiment, the period of time can be at least 4 hours. In yet another embodiment, the period of time can be at least 5 hours. In a further embodiment, the period of time can be at least 6 hours.

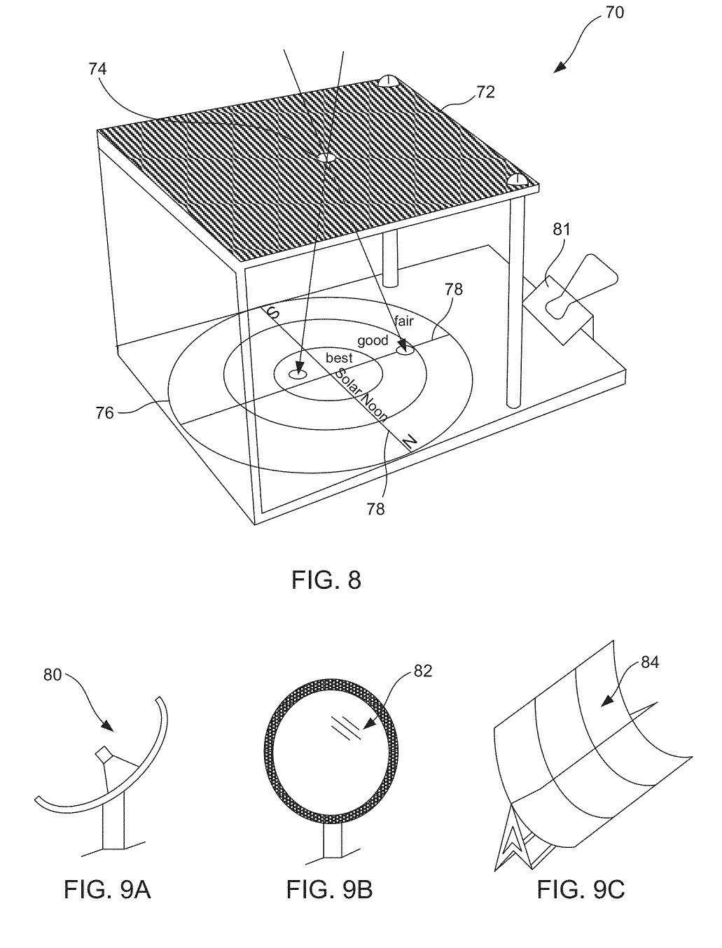

The sun movement targeting device 70 can be comprised of an opaque surface 72, an optical opening 74, and an optical target 76 with tracking axes 78. (see FIG. 8.) The sun movement targeting device can be made from any material, and is typically weather resistant (though a paper disposable device can be made in one example). The material can comprise wood, metal, glass, ceramic, plastic, polymeric materials, or combinations thereof. In one embodiment the sun movement targeting device is clear with the exception of the opaque surface for improved viewing of the optical target. The optical opening can allow a spot of direct sunlight therethough. In some embodiments, the spot of sunlight can be seen on the optical target.

In other embodiments, the optical target with tracking axes can be affixed onto a surface of the sun movement targeting device. In still other embodiments, the optical target with tracking axes can be engraved into a surface of the sun movement targeting device. In some embodiments, the optical target can be positioned from 3 to 10 inches directly beneath the opaque surface. In one embodiment, the target with the tracking axes can be configured to allow the user to properly align the single axis rotation system 10 with the rotational direction of the sun. Aligning the single axis rotation system with the rotational direction of the sun can permit the user to acquire maximum energy output from the solar device 62.

The single axis rotation system 10, can be configured to be attached to a stand 47. (see FIGS. 1, 5, and 6.) In one embodiment, the attachment point can be at the main body 34 of the first support body on the single axis rotation system. In one embodiment, the stand can be comprised of a body 48 and a set of legs that collectively form a base 54. (see FIG. 5.) In some embodiments, the stand can further comprise a first rotational mechanism 50, a second rotational mechanism 52, and/or a battery support 56.

When the stand comprises a first rotatable mechanism, the mechanism can be adapted to adjust the solar device, when installed, along a planar rotation axis. In one embodiment, the first rotatable mechanism can be adapted to allow for rotation of the solar device to at least 90°. In another embodiment, the first rotatable mechanism can be adapted to allow for rotation of the solar device to at least 120°. In yet another embodiment, the first rotatable mechanism can be adapted to allow for rotation of the solar device to at least 180°, or even 360° in some examples.

When the stand comprises a second rotatable mechanism, the mechanism can be adapted to align a face of the solar device, when installed, in a direction that faces the sun, e.g., the vertical post of body of the stand rotates. In one embodiment, the second rotatable mechanism can be adapted to allow for rotation of the solar device to at least 90°. In another embodiment, the second rotatable mechanism can be adapted to allow for rotation of the solar device to at least 180°. In yet another embodiment, the second rotatable mechanism can be adapted to allow for rotation of the solar device to at least 270°. In a further embodiment, the second rotatable mechanism can be adapted to allow for rotation of the solar device to at least 360°. When present, the battery support can be positioned at or near a base of the stand. In some embodiments, the battery support can be detachable from the stand. In one embodiment, the weight of the battery support can allow the single axis rotation system to be used without securing the stand to a support structure. In another embodiment, the battery support combined with a battery that is in position can be weighted to allow the single axis rotation system to be used without securing the stand to the ground.

In one embodiment, the stand can be broken down for compact storage. When compactable the body of the stand can be broken down into several body pieces. For example, each of the legs can be separate from one another. In yet another embodiment, the legs can be integrated into a single base. When incorporated into a single base, the legs can be adapted to be rotational and/or to fold.

The single axis rotation system 10 can be further adapted to support a charge controller 60 and a battery 58. (see FIG. 5.) When the system supports a charge controller, the charge controller can be detachable attached to the body or vertical post 48 of the stand 47. When the system supports a battery 58 adapted for electrical communication with the solar device and/or charge connector the battery can be placed on the battery support 56 of the stand. In some embodiments, the battery can be adapted to provide the electrical power for the actuator 12.

In a particular embodiment, presented herein is a single axis rotation system for use with a solar device. The system can be comprised of an actuator, a pulley system, a rotatable shaft, and a sun following sensor. In this embodiment, the actuator, pulley system, rotatable shaft and sun following sensor can be as previously discussed. In one embodiment, the system described above can further comprise a solar device. In another embodiment, the solar device can be in electrical communication with a charge controller and a battery. In yet another embodiment, the above system can further comprise a sun movement targeting device in coplanar or parallel position with respect to the solar device to assist in determining a single axis that faces the sun over a period of time during daylight hours of at least 2 hours, at least 4 hours, at least six hours, at least 8 hours, at least 12 hours, or from sunrise to sunset, for example.

Also presented herein is a method for tracking the sun. The method of tracking the sun can allow for efficient use of a solar device. In one embodiment, the method can comprise affixing a solar device to a single axis rotatable support body with an operable face of the solar device positioned opposite the single axis rotatable body. Then fixedly coupling the single axis rotatable body to a base pulley of a pulley system which can be rotated by a movable arm of an actuator attached to a compliant band wrapped around the base pulley, thereby causing rotation of the single axis rotatable body when the base pulley rotates. The method can further comprise attaching a sun following sensor to the solar device in an orientation that is functionally aligned with the face of the solar device, electrically coupling a sun following sensor to the actuator, and electrically communicating information regarding position of the sun to the actuator to direct the face of the solar device toward the sun along the single axis. The solar device, pulley system, actuator, stand, and sun following sensor can be as previously discussed. In one embodiment, the solar device is a solar panel.

The systems, devices, and method presented herein can allow for efficient sun absorption because of the direction of a face of a solar device can be adapted to automatically track the sun. It will be readily apparent to those skilled in the art that various changes and modifications of an obvious nature may be made without departing from the spirit of the disclosed technology embodiments, and all such changes and modifications are considered to fall within the scope of the technology as recited herein, including in the appended claims. One example of such changes and modifications could include, but is not limited to, using a different stand in conjunction with the single axis rotation system

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

1. A single axis rotation system for use with a solar device, comprising:
an actuator comprising a movable arm; a pulley system comprising a base pulley, a collaborative pulley, and a compliant band about the base pulley and the collaborative pulley, the movable arm attached to the compliant band such that when the movable arm actuates, the compliant band causes the base pulley and the collaborative pulley to move; and
a rotatable shaft attached to the base pulley and configured to rotate when the base pulley rotates, wherein the rotatable shaft is configured to be attached to a solar device to rotate the solar device along a single axis in an outward orientation with respect to the rotatable shaft.

2. (canceled)

3. The single axis rotation system of claim 2, wherein the motor is configured to actuate the movable arm thereby extending or retracting the movable arm from the body of the actuator.

4. (canceled)

5. (canceled)

6. (canceled)

7. (canceled)

8. (canceled)

9. The single axis rotation system of claim 1, wherein the base pulley is located at or near a central axis about the rotatable shaft and the collaborative pulley is distal to the central axis.

10. (canceled)

11. (canceled)

12. (canceled)

13. The single axis rotation system of claim 1, wherein the compliant band is wrapped around the base pulley at least twice.

14. (canceled)

15. (canceled)

16. The single axis rotation system of claim 1, wherein the movable arm is attached to the compliant band by a guide.

17. The single axis rotation system of claim 16, wherein the guide is configured to actuate when the movable arm actuates.

18. The single axis rotation system of claim 17, wherein the compliant band is configured to rotate the base pulley and the collaborative pulley.

19. The single axis rotation system of claim 16, wherein the guide is further attached to a first support body.

20. (canceled)

21. (canceled)

22. The single axis rotation system of claim 1, wherein the rotatable shaft is connected at each terminal end to a second support body.

23. The single axis rotation system of claim 22, wherein the second support body is an adjustable support body.

24. (canceled)

25. (canceled)

26. (canceled)

27. (canceled)

28. (canceled)

29. (canceled)

30. (canceled)

31. (canceled)

32. The single axis rotation system of claim 1, further comprising a sun following sensor adapted to communicate with the actuator and direct the actuator to extend or retract, thereby causing the solar device, when installed, to follow the sun.

33. (canceled)

34. (canceled)

35. (canceled)

36. The single axis rotation system of claim 1, further comprising a sun movement targeting device in functional alignment with an exterior sun interfacing surface of the solar device to assist in determining a single axis that faces the sun over a period of time during daylight hours of at least 2 hours.

37. (canceled)

38. The single axis rotation system of claim 37, wherein the optical target with the tracking axes is configured to allow the user to properly align the single axis rotation system with the rotational direction of the sun.

39. The single axis rotation system of claim 1, wherein the single axis rotation system is configured to be attached to a stand.

40. The single axis rotation system of claim 39, wherein the stand comprises a first rotatable mechanism that is adapted to adjust the solar device, when installed, along a planar rotation axis.

41. (canceled)

42. The single axis rotation system of claim 39, wherein a body of the stand comprises a second rotatable mechanism that is adapted to align a face of the solar device, when installed, in a direction that faces the sun.

43. (canceled)

44. The single axis rotation system of claim 42, wherein the stand includes a battery support.

45. The single axis rotation system of claim 44, wherein the battery support is positioned near a base of the stand such that when a battery is in position, the detachable battery support and battery is weighted such to allow the single axis rotation system to be used without securing the stand to the ground or other structure.

46. (canceled)

47. (canceled)

48. (canceled)

49. (canceled)

50. (canceled)

51. (canceled)

52. (canceled)

53. (canceled)

54. A method of tracking the sun for efficient use of a solar device, comprising:
affixing a solar device to a single axis rotatable support body with an operable face of the solar device positioned opposite the single axis rotatable body; fixedly coupling the single axis rotatable body to a base pulley of a pulley system which is rotated by a movable arm of an actuator attached to a compliant band wrapped around the base pulley, thereby causing rotation of the single axis rotatable body when the base pulley rotates;
attaching a sun following sensor to the solar device in an orientation that is
functionally aligned with the face of the solar device;
electrically coupling a sun following sensor to the actuator;
electrically communicating information regarding position of the sun to the actuator to direct the face of the solar device toward the sun along the single axis.

55. (canceled)

56. (canceled)

57. A sun movement targeting device for use with a single axis rotational solar device, comprising:
an opaque surface with an optical opening to allow a spot of direct sunlight therethrough; an optical target positioned at from 3 to 10 inches directly beneath the opaque surface,
and having tracking axes included thereon; and
a fastening portion to attach the sun movement targeting device in an operational coplanar or parallel orientation with respect to a flat surface of a solar device.
